(19) United States
(12) Patent Application Publication
(10) Pub. No.: US 2007/0156511 A1
(43) Pub. Date: Jul. 5, 2007

(54) Dependent object deviation

(76) Inventors: Gregor Arlt, Heidelberg (DE); Silke Storch, Rauenberg (DE); Klaus Bahr, Karlsruhe (DE)

Correspondence Address: SCHWEGMAN, LUNDBERG, WOESSNER & KLUTH, P.A., P.O. BOX 2938, MINNEAPOLIS, MN, 55402, US

(21) Appl. No.: 11/322,329

(22) Filed: Dec. 30, 2005

(51) Int. Cl. G06F 11/34

(52) U.S. Cl. 705/11

(57) ABSTRACT

In an embodiment, a computer-based process is configured to execute a business process based on a set of rules. The computer-based process is further configured to execute the business process based on a deviation from the set of rules. The set of rules is applicable to the business process, and the deviation from the set of rules is at times applicable to the business process. One or more correction activities can be implemented by analyzing the deviations from the set of rules.

### BACKGROUND

Whether mentally-based, paper-based, computer-based, or a combination thereof, virtually every business organization follows a set of business processes, and most business organizations attempt to gage the effectiveness of their business processes. For example, a grocery store may use a particular business process to inspect incoming goods, such as the inspection of a certain percentage of the cases of a product that comes into the store. If the product is olive oil, the store may do a quality check on parameters such as clarity, viscosity, aroma, and taste. Each time that a case is tested, these parameters will be measured. As another example, a business organization that employs one or more contract employees may check on a periodic basis to determine if the employees are carrying out the terms of the contract—i.e., is the employee present, did the employee show up on time, and did the employee fulfill the duties of the contract on a particular day. Therefore, whatever the business organization, such quality assurance checks may be made on a periodic basis and the results may be recorded.

In carrying out their inspection processes, these business organizations may be exposed to special circumstances that do not normally occur with every inspection. For example, in the situation of the grocery store examining the olive oil, there may be times when one or more bottles in a case are broken. Similarly, in the example relating to an employee contract, an employee may not have showed up for work because the employee may have died. The art is in need of a system that can analyze business processes and handle specialized circumstances in a standardized manner.

### SUMMARY

In an embodiment, a computer-based process is configured to execute a business process based on a set of rules. The computer-based process is further configured to execute the business process based on a deviation from the set of rules. The set of rules is applicable to the business process, and the deviation from the set of rules is at times applicable to the business process. One or more correction activities can be implemented by analyzing the deviations from the set of rules.

### BRIEF DESCRIPTION OF THE DRAWINGS

FIG. 1 illustrates an example embodiment of an architecture encompassing inspection rules, deviations from those inspection rules, a quality code hierarchy, and a dependent object deviation.

FIG. 2 illustrates an example embodiment of a deviation detail.

FIG. 3 illustrates an example embodiment of a deviation detail within a particular application platform.

FIG. 4 illustrates an example embodiment of an architecture of a deviation, a deviation detail, and a quality code hierarchy.

FIG. 5 illustrates an example embodiment of a computer system upon which one or more embodiments of the invention may execute.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

The functions or algorithms described herein are implemented in software or a combination of software and human implemented procedures in one embodiment. The software comprises computer executable instructions stored on computer readable media such as memory or other type of storage devices. The term “computer readable media” is also used to represent carrier waves on which the software is transmitted. Further, such functions correspond to modules, which are software, hardware, firmware or any combination thereof. Multiple functions are performed in one or more modules as desired, and the embodiments described are merely examples. The software is executed on a digital signal processor, ASIC, microprocessor, or other type of processor operating on a computer system, such as a personal computer, server or other computer system.

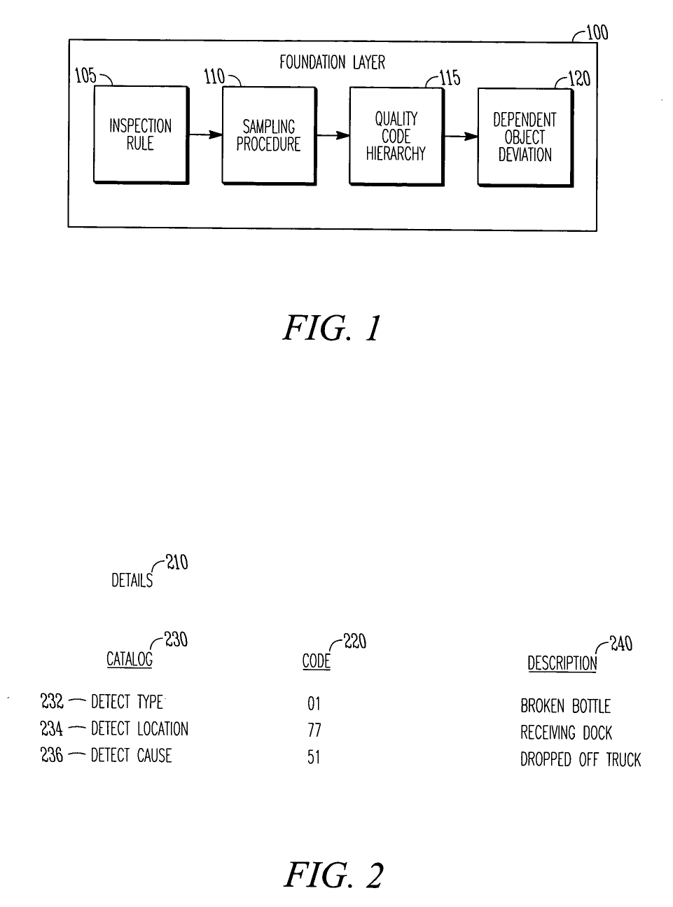

FIG. 1 illustrates an example embodiment of a foundation layer 100 that may be used to examine, inspect, evaluate, and report on the results of a business process. In an embodiment, the foundation layer 100 of FIG. 1 may be computer-based. Specifically, FIG. 1 illustrates that within the foundation layer 100 resides an inspection rule 105 (or a first set of inspection rules) that is used to evaluate a business process. In this embodiment, the inspection rule 105 is almost always applicable to the business process. For example, the business process may relate to the inspection of goods coming into the inventory of a grocery store, and certain goods almost always have certain features that are evaluated to determine the quality of the good. For example, a sample of olive oil may virtually always be evaluated for color and clarity. The inspection rule 105 is further related to a sampling procedure 110, which may include the parameters of how often a sample is taken of the incoming goods, and the tests that are performed on that sample. Once again, if the incoming good is olive oil, then the sampling procedure 110 may require that two bottles from every tenth case of olive oil be examined for clarity, viscosity, taste, and aroma. The results of the examination outlined in the sampling procedure 110 may be reported using a quality code hierarchy 115.

In the course of these evaluations using the inspection rule 105, the sampling procedure 110, and the quality code hierarchy 115, a situation may arise that while not completely unexpected, does not occur all the time and hence does not have to be addressed in each sample of the goods. For example, referring again to olive oil, while the two bottle sample of olive oil is always susceptible to a color, clarity, taste, and aroma analysis, a defect such as a broken bottle, while it invariably will occur at some point in time, will more than likely not happen in every sample. However, when such a situation occurs, one or more embodiments handle this by invoking a Dependent Object (DO) Deviation 120. The DO Deviation 120 uses another set of rules in the quality code hierarchy 115 to address deviation situations such as a broken bottle of olive oil. The code pertaining to the broken bottle of olive oil, or a code from the hierarchy 115 to identify other deviations, is used throughout the system. Because these deviations are strictly identified and used throughout the system, this imparts consistency and repeatability to the system. The results of the inspection rule 105 and the deviation 120 may be recorded, and these results may be analyzed over a period of time and trends or problems with certain manufacturers, suppliers and/or distributors may be identified and addressed. One advantage of the codes in the hierarchy 115 is that they address a free text problem. The free text problem relates to situations in which the same or similar deviations are described by different individuals using different text, thereby resulting in inconsistencies throughout the system. However, by using the code hierarchies 115, the same description for a particular event is logged all the time, thereby eliminating the inconsistency problem.

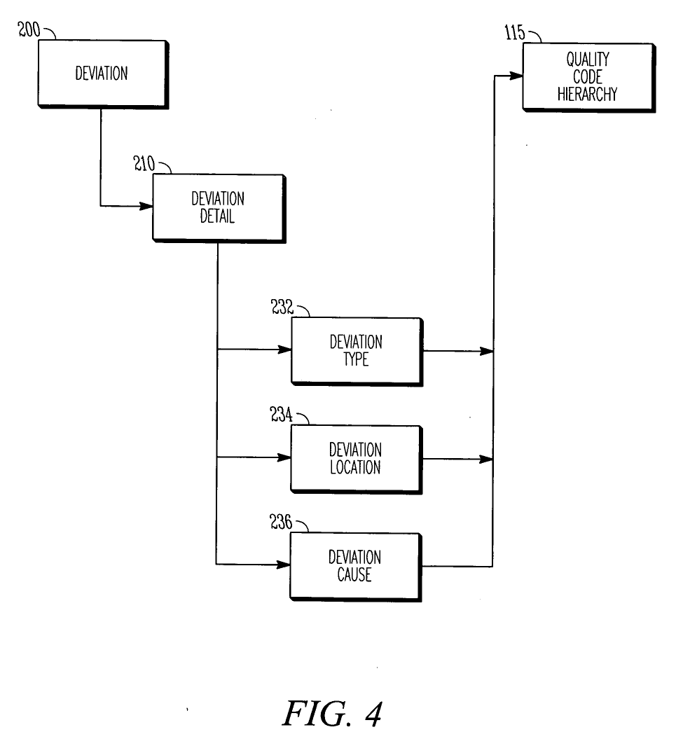

The codes in the hierarchy 115 relating to a deviation 120 contain and convey detailed information about the occurrences of the deviation. In an embodiment, the details of a deviation are cataloged and identified by a code. FIG. 2 illustrates a relationship between a deviation detail, a catalog, a code, and a description. Referring to FIG. 2, the deviation detail 210 is identified by a code 220, a catalog 230, and a standard description 240. In an embodiment, the codes 220 convey information concerning the type of occurrence 232, the location of the occurrence 234, and the cause of the occurrence 236. Referring again to the grocery store example, and in particular the inspection of the olive oil, the type of the occurrence may be that one or more of the bottles of olive oil are broken. Once again, this is an occurrence that, while not unheard of, will more than likely not occur in every inspection. Additionally, the location of the occurrence may be noted (e.g., on the receiving dock of the store), and if known, the cause of the occurrence (e.g., case dropped from truck). FIG. 4 illustrates the logical connection among the deviation 200, the deviation detail 210, the deviation type 232, the deviation location 234, the deviation cause 236, and the quality code hierarchy 115.

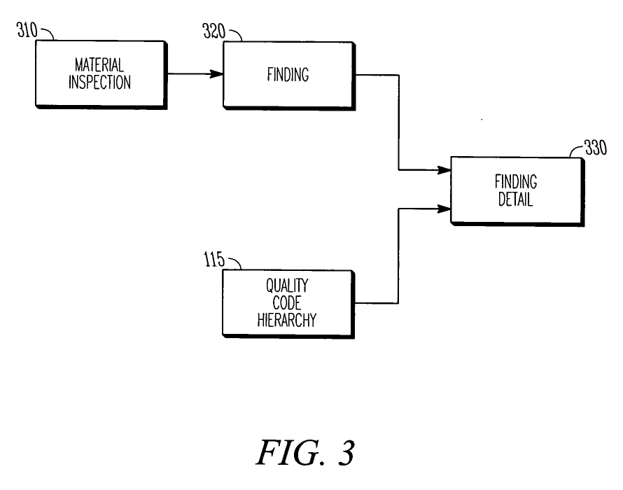

In another embodiment, the foundation layer 100 illustrated in FIG. 1 may be installed onto an existing platform of business processes. An example embodiment of such an installation is illustrated in part in FIG. 3. For example, as FIG. 3 illustrates, an existing business object may deal with a material inspection 310. As discussed in connection with FIG. 1, the business object material inspection 310 may almost always deal with certain occurrences such as clarity, viscosity, taste, and aroma in the olive oil example. Then, an occurrence of a deviation results in the invocation of a dependent object deviation 120—i.e., an object that depends on the occurrence of an event that while not unexpected, does not always occur in the business process. Such an occurrence may also be referred to as a finding 320. The finding 320 results in a finding detail 330, which uses the quality code hierarchy 115 for access to the catalog 230, code 220, and description information 240 in the hierarchy.

While certain embodiments have been described in relation to specific examples such as in connection with the inspection of product in a grocery store (inventory quality inspection) and employee contract verification, it is noted that the invention is not limited to these two examples. Embodiments may be applied to virtually any business process, such as invoice checking and customer relations management (CRM), to monitor and evaluate those processes.

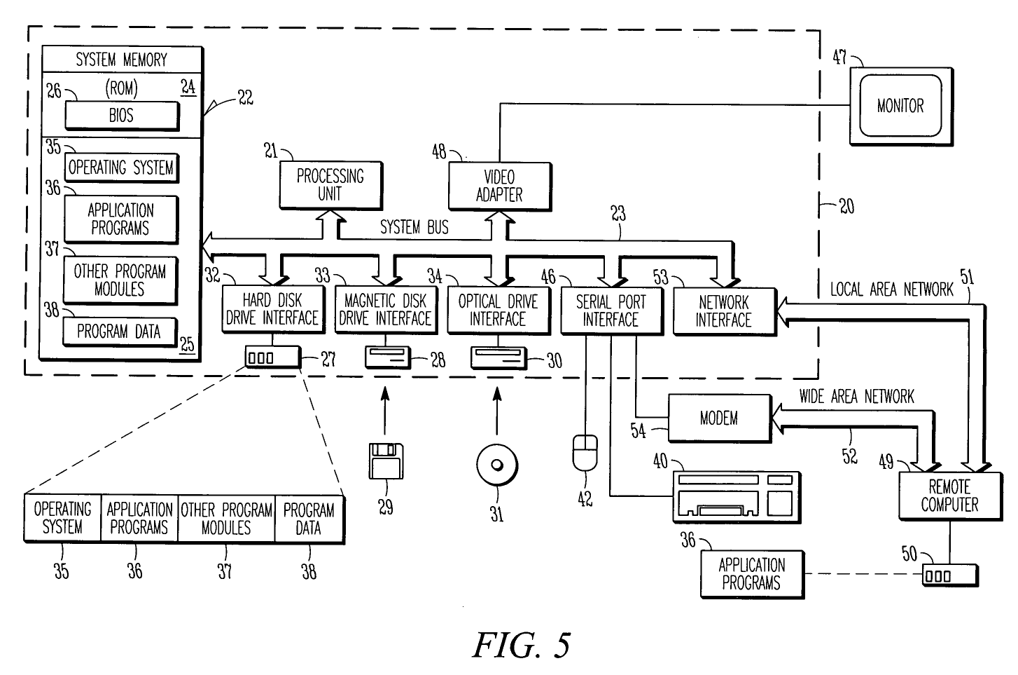

FIG. 5 is an overview diagram of a hardware and operating environment in conjunction with which embodiments of the invention may be practiced. The description of FIG. 5 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCS, minicomputers, mainframe computers, and the like. The invention may also be practiced in distributed computer environments where tasks are performed by I/O remote processing devices that are linked through a communications network. In a distributed computing environment, program modules may be located in both local and remote memory storage devices.

In the embodiment shown in FIG. 5, a hardware and operating environment is provided that is applicable to any of the servers and/or remote clients shown in the other Figures.

As shown in FIG. 5, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 40 can display a graphical user interface for the user. In addition to the monitor 40, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above I/O relative to the computer 20, although only a memory storage device 50 has been illustrated. The logical connections depicted in FIG. 5 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. A process comprising:
configuring a computer-based process to execute a business process based on a set of rules; and
configuring the computer-based process to execute the business process based on a deviation from the set of rules;
wherein:
the set of rules is applicable to the business process; and
the deviation from the set of rules is at times applicable to the business process;
whereby one or more correction activities can be implemented by analyzing the deviations from the set of rules.

2. The process of claim 1, wherein the deviation from the set of rules comprises a set of codes associated with the business process, and the codes relate to quality categories.

3. The process of claim 2, wherein the quality categories comprise a deviation type, a deviation cause, and a deviation location.

4. The process of claim 2, wherein the quality categories are part of a quality code hierarchy, and further wherein the quality code hierarchy is available for the evaluation of other business processes.

5. The process of claim 1, further comprising:
configuring the process to evaluate the business process based on
a defect; and
a laboratory finding;
wherein
the defect comprises a defect type, a defect cause, and a defect location; and
the laboratory finding comprises a laboratory finding type, a laboratory finding cause, and a laboratory finding location.

6. The process of claim 1, further comprising:
analyzing the deviation;
identifying points in the business process contributing to the deviation; and
implementing one or more correction activities based on the analysis and identification.

7. The process of claim 2, wherein the codes identify a standard description for the quality categories.

8. The process of claim 1, wherein the set of rules relates to a business process that comprises at least one of inventory quality inspection, invoice checking, contract verification, or customer relations management.

9. A system comprising:
a module to configure a computer-based process to execute a business process based on a set of rules; and
a module to configure the computer-based process to execute the business process based on a deviation from the set of rules;
wherein:
the set of rules is applicable to the business process; and
the deviation from the set of rules is at times applicable to the business process;
whereby one or more correction activities can be implemented by analyzing the deviations from the set of rules.

10. The system of claim 9, wherein the deviation from the set of rules comprises a set of codes associated with the business process, and the codes relate to quality categories.

11. The system of claim 10, wherein the quality categories comprise a deviation type, a deviation cause, and a deviation location.

12. The system of claim 10, wherein the quality categories are part of a quality code hierarchy, and further wherein the quality code hierarchy is available for the evaluation of other business processes.

13. The system of claim 9, further comprising:
a module to analyze the deviation;
a module to identify points in the business process contributing to the deviation; and
a module to implement one or more correction activities based on the analysis and identification.

14. The system of claim 10, wherein the codes identify a standard description for the quality categories.

15. A machine-readable medium comprising instructions thereon for executing a process comprising:
configuring a computer-based process to execute a business process based on a set of rules; and
configuring the computer-based process to execute the business process based on a deviation from the set of rules;
wherein:
the set of rules is applicable to the business process; and
the deviation from the set of rules is at times applicable to the business process;
whereby one or more correction activities can be implemented by analyzing the deviations from the set of rules.

16. The machine-readable medium of claim 15, wherein the deviation from the set of rules comprises a set of codes associated with the business process, and the codes relate to quality categories.

17. The machine-readable medium of claim 16, wherein the quality categories comprise a deviation type, a deviation cause, and a deviation location.

18. The machine-readable medium of claim 16, wherein the quality categories are part of a quality code hierarchy, and further wherein the quality code hierarchy is available for the evaluation of other business processes.

19. The machine-readable medium of claim 15, further comprising instructions for:
analyzing the deviation;
identifying points in the business process contributing to the deviation; and
implementing one or more correction activities based on the analysis and identification.

20. The machine-readable medium of claim 16, wherein the codes identify a standard description for the quality categories.
